(19) United States
(12) Patent Application Publication
(10) Pub. No.: US 2009/0191460 A1
(43) Pub. Date: Jul. 30, 2009

(54) NONAQUEOUS SECONDARY BATTERY AND METHOD FOR PRODUCING THE SAME

(75) Inventors: Isao FUJIWARA, Osaka (JP); Yasuhiro UEYAMA, Hyogo (JP); Takao KUROMIYA, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/345,729

(22) Filed: Dec. 30, 2008

(30) Foreign Application Priority Data
Jan. 30, 2008 (JP) 2008-018873
Nov. 5, 2008 (JP) 2008-284490

(51) Int. Cl. H01M 4/04; H01M 4/02; H01M 10/02

(52) U.S. Cl. 429/209; 427/77

(57) ABSTRACT

An object of the present invention is to provide a nonaqueous secondary battery with high capacity and less cycle degradation and a method for producing thereof. The nonaqueous secondary battery of the present invention comprises a positive electrode having a positive electrode current collector and a positive electrode mixture layer disposed on the positive electrode current collector, a negative electrode having a negative electrode current collector and a negative electrode mixture layer disposed on the negative electrode current collector and a separator disposed between the positive electrode and the negative electrode, wherein the positive electrode mixture layer or the negative electrode mixture layer contains active material particles and a particulate binder adhered to the surface of the active material particles.

### CROSS REFERENCE TO RELATED APPLICATIONS

The disclosure of Japanese Patent Application No. 2008-018873 filed on Jan. 30, 2008 and the disclosure of Japanese Patent Application No. 2008-284490 filed on Nov. 5, 2008 including the specification, drawings and abstract are incorporated herein by reference in its entirety.

### BACKGROUND OF THE INVENTION

1. Field of the Invention

The present invention relates to a nonaqueous secondary battery represented by a lithium ion battery and a method for producing the same.

2. Description of the Related Art

In recent years, rechargeable lithium ion batteries have been greatly expected in the industry for use in mobile applications because of its performance for providing high capacity and high energy density. These batteries are composed of a positive electrode, a negative electrode and a separator (such as an insulating porous polymer film or the like) disposed between the positive electrode and the negative electrode.

The positive electrode and negative electrode have a current collector, a mixture layer containing active material (positive electrode active material or negative electrode active material) an electrically conductive material and a binder formed on the current collector. For the active material (negative electrode active material) of a negative electrode mixture layer, a carbonaceous material capable of absorbing and releasing lithium or the like is used, and for the active material (positive electrode active material) of a positive electrode mixture layer, a composite oxide of a transition metal and lithium such as LiCoO₂ or the like is used. Accordingly, rechargeable lithium ion batteries have high capacity and high energy density. The mixture layer is formed by applying a paint (a positive electrode paint or a negative electrode paint) prepared by mixing an active material (a positive electrode active material or a negative electrode active material), an electrically conductive material, a binder and a solvent to the current collector and drying the applied paint.

In general, as the density of an active material in the mixture layer increases, the capacity of a rechargeable lithium ion battery increases. As the multifunction of electronic and communication devices has progressed in recent years, a rechargeable lithium ion battery is desired to have a further higher capacity.

In order to achieve a higher capacity of a rechargeable lithium ion battery, it is considered that the percentage of a binder in a mixture layer is reduced and the density of an active material is increased, because the binder makes no contribution to absorbing and releasing lithium. In order to reduce the percentage of the binder in a mixture layer, it is required that the binding strength of the binder is improved or the binder is uniformly distributed in a positive electrode paint or a negative electrode paint applied to the current collector.

As an attempt to improve the binding strength of a binder, a method of introducing a specific functional group into a molecule contained in a binder (for example, refer to Japanese Patent Application Laid-Open No. H10-298386), a method of using a rubber-based resin binder (for example, refer to Japanese Patent Application Laid-Open No. 2005-123047) and the like have been tried. In addition, as an attempt to uniformly distribute a binder in a paint, a method of remelting a binder (for example, refer to Japanese Patent Application Laid-Open No. H07-6752, Japanese Patent Application Laid-Open No. H07-220722 and Japanese Patent Application Laid-Open No. 2007-273259), a method of applying a binder and a paint separately (for example, refer to Japanese Patent Application Laid-Open No. 2002-246013) and the like have been tried.

In Japanese Patent Application Laid-Open No. H10-298386, a method of using a sulfonated polyvinylidene fluoride-based resin as a binder is described as a method of using a molecule for a binder into which a specific functional group is introduced.

In Japanese Patent Application Laid-Open No. 2005-123047, a method of preventing a mixture layer from peeling off from a current collector by using a flexible rubber-based resin binder is described. According to the method as described in Japanese Patent Application Laid-Open No. 2005-123047, the space between solid particles such as an electrically conductive material, a positive electrode active material or the like may be reduced by using a flexible binder composed of an acrylonitrile-butadiene based rubber and a polyvinylidene fluoride-based polymer, and therefore the volume loss may be reduced. Accordingly, even if the content of a binder is low, there may be formed a mixture layer in which the density of active material is high and mechanical strength is sufficiently secured.

In Japanese Patent Application Laid-Open No. H07-6752, a production method of an electrode including the step of heating a mixture layer after forming the mixture layer is described. In Japanese Patent Application Laid-Open No. H07-220722, a method in which a raw material for an electrode containing a thermoplastic resin (binder) is kneaded to make a slurry, the slurry is applied to a current collector and then the applied slurry is to the current collector is heated at a melting temperature or higher of the thermoplastic resin, is described. In Japanese Patent Application Laid-Open No. 2007-273259, a production method of a nonaqueous electrolyte secondary battery including the steps of: mixing a positive electrode active material, an electric conductive material and polyfluoride vinylidene (a binder) with N-methylpyrrolidone to make a slurry; applying the slurry to a current collector and drying the applied slurry to prepare a positive electrode having a positive electrode active material layer; roll-pressing the positive electrode; and heating the positive electrode after rolling at a temperature range of Tm−30≦T≦Tm+20 (here, Tm is a melting point of polyfluoride vinylidene in the positive electrode active material layer after rolling) for one hour or longer under air atmosphere, is described.

On the other hand, in Japanese Patent Application Laid-Open No. 2002-246013, a production method of a negative electrode for a rechargeable lithium ion battery including the steps of; applying a solution containing a binder to the surface of a current collector; drying the applied solution on the surface of a current collector to form a layer of the binder; applying the slurry containing an active material and the binder to the layer of the binder and drying the applied slurry is described.

### SUMMARY OF THE INVENTION

The above-mentioned conventional methods as described in Japanese Patent Application Laid-Open No. H10-298386, Japanese Patent Application Laid-Open No. 2005-123047, Japanese Patent Application Laid-Open No. H07-6752, Japanese Patent Application Laid-Open No. H07-220722, Japanese Patent Application Laid-Open No. 2007-273259 and Japanese Patent Application Laid-Open No. 2002-246013 are methods in which firstly an active material, a binder and an electrically conductive material are added and kneaded in a solvent to make a paint and the paint is applied to a current collector and the applied paint is dried to form a mixture layer. In an application film (applied paint) set on the current collector, the paint at the surface of the application film is first dried and the paint at the current collector side of the application film is finally dried. In this manner, when there is variation in the drying rate of the paint within the application film. Because of the variation in the drying rate of the paint within the application film the binder in the application film was attracted to the surface of the application film by convection in the application film during the application film is dried. Therefore, after drying of the application film, the binder is localized at the surface of the mixture layer in some cases. When a binder is localized at the surface of a mixture layer, the bonding strength between the mixture layer and the current collector is reduced.

FIG. 1 shows a process of forming a positive electrode of a nonaqueous secondary battery by a wet process (a technique of forming a mixture layer by applying paint to a current collector and drying the applied paint) as the conventional techniques as described in Japanese Patent Application Laid-Open No. H10-298386, Japanese Patent Application Laid-Open No. 2005-123047, Japanese Patent Application Laid-Open No. H07-6752, Japanese Patent Application Laid-Open No. H07-220722, Japanese Patent Application Laid-Open No. 2007-273259 and Japanese Patent Application Laid-Open No. 2002-246013. FIG. 1A shows a state in which a paint 15 in which active material 13, a binder and an electrically conductive material are dispersed is applied to current collector 11 to form application film 17.

FIG. 1B shows a process of drying application film 17 by heating application film 17 that is formed. In application film 17, convection occurs because the paint at the surface is first dried. On the other hand paint 15 containing a binder and an electrically conductive material at the lower part which paint is not dried is attracted to the surface of application film 17.

FIG. 1C shows mixture layer 19 on current collector 11 formed by drying of application film 17. As shown in FIG. 1B, since a paint containing a binder and an electrically conductive material is attracted to the surface of an application film, binder 21 and the electrically conductive material are localized at the surface of mixture layer 19 and binder 21 runs short between mixture layer 19 and current collector 11. Accordingly, the bonding strength between mixture layer 19 and current collector 11 is reduced. In this manner, in the formation method of a mixture layer with a wet process, a uniform distribution of a binder may not be obtained in the mixture layer. Accordingly, in the formation method of a mixture layer with a wet process, in order to secure a sufficient bonding strength between a mixture layer and a current collector, the amount of a binder used tends to become large.

In addition, in a method as described in Japanese Patent Application Laid-Open No. 2002-246013 to provide a binder layer between a mixture layer and a current collector, the binder is prevented from peeling off from the current collector. However, since the problem of the localization of the binder in the mixture layer is still unsolved, the binder ran short at the interface between the binder layer and the mixture layer and the mixture layer was peeled off from the binder layer in some cases.

An object of the present invention is to provide an electrode for a nonaqueous secondary battery with high capacity and less cycle degradation by reducing the percentage of a binder in a mixture layer by uniformly dispersing the binder in the mixture layer and a production method thereof. Another object of the present invention is to provide a production method of a binder and a method of fixing a mixture layer to a current collector.

The first of the present invention relates to the following nonaqueous secondary battery.

(1) A nonaqueous secondary battery having a positive electrode having a positive electrode current collector and a positive electrode mixture layer disposed on the positive electrode current collector, a negative electrode having a negative electrode current collector and a negative electrode mixture layer disposed on the negative electrode current collector and a separator disposed between the positive electrode and the negative electrode, wherein the positive electrode mixture layer or the negative electrode mixture layer contains active material particles and particulate binders adhered to the surface of the active material particle.

(2) The nonaqueous secondary battery as described in (1), wherein the average particle size of the particulate binders is 1/1000 to 1/10 of the average particle size of the active material particles.

(3) The nonaqueous secondary battery as described in (1) or (2), wherein the particulate binders have an average particle size of 0.01 to 10 μm.

(4) The nonaqueous secondary battery as described in any of (1) to (3), wherein the active material particles have an average particle size of 1 to 50 μm and the particulate binders have an average particle size of 0.05 to 0.15 μm.

(5) The nonaqueous secondary battery as described in any of (1) to (4), wherein the mixture layer containing the active material particles and particulate binders contains 0.6 to 3.0 parts by weight of the particulate binder, with respect to 100 parts by weight of the active material particles.

(6) The nonaqueous secondary battery as described in any of (1) to (5), wherein an electrically conductive material is contained in the particulate binder, and the mixture layer containing the active material particles and particulate binders contains 0.3 to 3.0 parts by weight of the electrically conductive material, with respect to 100 parts by weight of the active material particles.

(7) The nonaqueous secondary battery as described in any of (1) to (6), wherein the binder is a resin containing a fluorine atom.

(8) The nonaqueous secondary battery as described in any of (1) to (7), wherein the following conditions are satisfied: X−2≦Y≦X+2 and X−2≦A≦X+2, when the mixture layer containing the active material particles and the particulate binder is divided into equal slices of layer:a layer A having a surface contacting with the positive electrode current collector or the negative electrode current collector,a layer C having a surface contacting with the separator and a layer B sandwiched between the layer A and the layer C, and the volume percentage of the binder in the whole mixture layer containing the active material particles and the particulate binders is defined as X (vol/vol %), and the volume percentage of the binder in the layer A is defined as Y (vol/vol %) and the volume percentage of the binder in the layer C is defined as Z (vol/vol %).

(9) the nonaqueous secondary battery as described in (7), wherein the following conditions are satisfied: X−2≦Y≦X+2 and X−2≦Z≦X+2, when the mixture layer containing the active material particles and the particulate binders is divided into equal slices of layer: a layer A having a surface contacting with the positive electrode current collector or the negative electrode current collector, a layer C having a surface contacting with the separator and a layer B sandwiched between the layer A and the layer C, the fluorine atom concentration in the whole mixture layer containing the active material particles and the particulate binders is defined as X (vol %), and the fluorine atom concentration in the layer A is defined as Y (vol %) and the fluorine atom concentration in the layer C is defined as Z (vol %).

(10) A nonaqueous secondary battery composed of an electrode group including a positive electrode having a positive electrode current collector and a positive electrode mixture layer disposed on the positive electrode current collector, a negative electrode having a negative electrode current collector and a negative electrode mixture layer disposed on the negative electrode current collector, and a separator disposed between the positive electrode and the negative electrode; a nonaqueous electrolyte; and a case enclosing the electrode group and the nonaqueous electrolyte, wherein the positive electrode mixture layer or the negative electrode mixture layer contains active material particles and the particulate binders adhered to the surface of the active material particle.

Further, the second of the present invention relates to the following methods for producing a nonaqueous secondary battery.

(11) A method for producing a nonaqueous secondary battery including a positive electrode having a positive electrode current collector and a positive electrode mixture layer disposed on the positive electrode current collector, a negative electrode having a negative electrode current collector and a negative electrode mixture layer disposed on the negative electrode current collector, and a separator disposed between the positive electrode and the negative electrode, including the steps of: providing active material particles and particulate binders, mixing the active material particles and the particulate binders to obtain a mixed powder, and fixing the mixed powder on the positive electrode current collector or the negative electrode current collector.

(12) The method for producing a nonaqueous secondary battery as described in (11), wherein the particulate binder contains an electrically conductive material and the step of providing the particulate binders includes the steps of: preparing a solution containing a raw material for the binder, the electrically conductive material and a solvent; spraying the solution to make the solution in a droplet state; and drying the solution in a droplet state to make the particulate binders containing the electrically conductive material.

(13) The method for producing a nonaqueous secondary battery as described in (12), wherein the concentration of the material for the binder is 4 to 12% by weight and the concentration of the electrically conductive material is 5 to 20% by weight in the solution.

(14) The method for producing a nonaqueous secondary battery as described in any of (11) to (13), wherein the particulate binders have an average particle size of 0.01 to 10 μm.

(15) The method for producing a nonaqueous secondary battery as described in any of (11) to (14), wherein a step of fixing the mixed powder on the positive electrode current collector or the negative electrode current collector includes the steps of: placing the mixed powder on the positive electrode current collector or the negative electrode current collector, and heating the placed mixed powder to melt the particulate binders in the mixed powder.

According to the production method of a nonaqueous secondary battery of the present invention, since an uniform distribution of a binder in a mixture layer is achieved, a desired bonding strength is secured with a less amount of a binder compared to the method of forming a mixture layer with a wet process, and therefore the density of an active material is further increased.

In addition, according to the production method of the present invention, since an uniform distribution of an electrically conductive material in a mixture layer is achieved, a desired electrical conductivity is secured with a less amount of an electrically conductive material, and therefore the density of an active material is further increased. Accordingly, the present invention provides a nonaqueous secondary battery with high capacity and less cycle degradation.

Further, in the present invention, since only a little surface area of the active material is coated by a binder, a nonaqueous secondary battery with higher capacity and high energy density is provided.

### BRIEF DESCRIPTION OF THE DRAWINGS

FIG. 1 shows a view illustrating a formation method of a mixture layer of a conventional nonaqueous secondary battery;

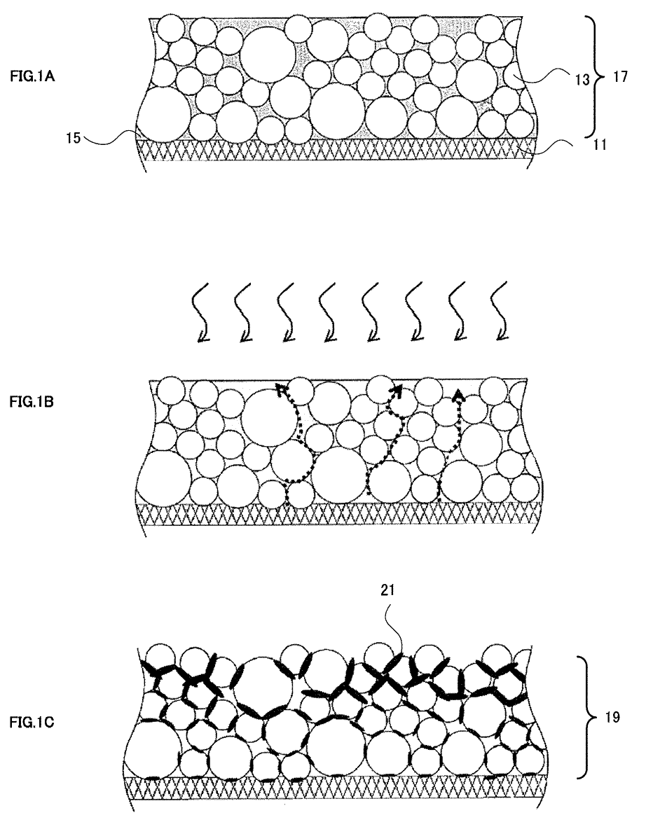

FIG. 2 is a cross-sectional perspective view of a nonaqueous secondary battery of the present invention;

FIG. 3 is a cross-sectional view of an electrode group for a nonaqueous secondary battery of the present invention;

FIG. 4 is a cross-sectional view of a positive electrode mixture layer;

FIG. 5 is a partially enlarged view of the electrode group shown in FIG. 3; and

FIG. 6 is an SEM photograph of the cross-section of a positive electrode mixture layer of a nonaqueous secondary battery of the present invention.

### DETAILED DESCRIPTION OF THE PREFERRED EMBODIMENT

1. Production Method of Nonaqueous Secondary Battery of the Present Invention

The production method of the present invention is a production method of a nonaqueous secondary battery composed of a positive electrode having a positive electrode current collector and a positive electrode mixture layer disposed on the positive electrode current collector, a negative electrode having a negative electrode current collector and a negative electrode mixture layer disposed on the negative electrode current collector, and a separator disposed between the positive electrode and the negative electrode.

The production method of the present invention includes (1) the first step of preparing particles of an active material (active material particles) and particulate binders, (2) the second step of mixing the active material particles and the particulate binders to obtain a mixed powder and (3) the third step of fixing the mixed powder on the positive electrode current collector or the negative electrode current collector. In this manner, the nonaqueous secondary battery of the present invention is characterized by forming a mixture layer with a dry process without using a paint such as a slurry and the like. In addition, the production method of the present invention is applicable to either a positive electrode or a negative electrode and is especially preferable for the production of a positive electrode because it is especially required to increase the active material density of a positive electrode mixture layer. Hereinafter, a case in which the production method of the present invention is applied to a positive electrode is explained.

(1) In the first step, the active material particles and the particulate binders are prepared.

A positive electrode active material is not particularly limited as long as it is capable of absorbing and releasing a lithium ion. The examples of the positive electrode active material include a composite oxide such as lithium cobalt oxide and its modified form (a solid solution of aluminum or magnesium and lithium cobalt oxide), lithium nickel oxide and its modified form (a modified form in which part of the nickel is replaced by cobalt, and the like), lithium manganese oxide and its modified form, and the like.

The material of the particulate binder is not particularly limited. The examples of the material of the binder include a thermoplastic resin such as a polyvinylidene fluoride (PVDF) and its modified form, polytetrafluoroethylene (PTFE), a rubber particle binder having an acrylate unit and the like. The material of the binder may contain an acrylate monomer or an acrylate oligomer into which a reactive functional group is further introduced. The particulate binders preferably have an average particle size of 0.01 to 10 μm. When the particulate binders have an average particle size of 0.01 to 10 μm, the particulate binder may enter into the space (0.01 to 10 μm) between the positive electrode active material particles having an average particle size of 1 to 100 μm which are generally used.

The particulate binder of the present invention may contain an electrically conductive material. By incorporating electrically conductive material to the particulate binder, electric conductivity may be given between active material particles with a less amount of an electrically conductive material. Examples of the electrically conductive material include carbon black such as acetylene black, ketjen black, channel black, furnace black, lamp black, thermal black and the like, and various graphites. These electrically conductive materials may be used alone, or may be used in combination of two or more kinds. The electrically conductive material preferably is fibrous and part of the electrically conductive material is preferably exposed from the particulate binder. When part of the electrically conductive material is exposed from the particulate binder, electric conductivity may be given between active material particles more effectively.

The production method of such particulate binders is not particularly limited, but the particulate binders may be produced, for example, with a spray drying method, a ball milling method or a freeze-grinding method or the like.

The spray drying method is a method in which a liquid is nebulized into hot wind and dried to obtain solid particles. For example, the method of forming a particulate binder with a spray-drying method includes (i) a step of preparing a solution containing a material for a binder and a solvent, (ii) a step of spraying the solution to make the solution in a droplet state, and (iii) a step of drying the droplet solution to form the particulate binders containing an electrically conductive material.

In the step (i), a solution containing a material for a binder, an electrically conductive material and a solvent is prepared. The solvent is not particularly limited as long as it may dissolve the above-mentioned material for a binder. Examples of such a solvent include an organic solvent such as N-methyl-2-pyrrolidone and the like. The concentration of the material for a binder in a solution is preferably 4 to 12% by weight. In addition, in the case of producing a particulate binder containing an electrically conductive material, an electrically conductive material may be contained in an amount of 5 to 20% by weight in a solution.

In the step (ii), the solution prepared in the step (i) is sprayed to make the solution in a droplet state. The particle size of the resulting particulate binder may be adjusted by the conditions for spraying the solution. The particulate binders having a desired average particle size (0.01 to 10 μm) are obtained, for example, by spraying the solution together with compressed air (approximately 0.4 MPa) in a radical pattern. In order to spray a solution in a radical pattern, the shape of the holes of the nozzle spraying a solution may be circular.

In the step (iii), the droplet solution is dried to obtain the particulate binders. In order to prevent the resulting particulate binders from the deterioration and deformation, the drying temperature is preferably the glass transition temperature of the binder or lower. The resulting particulate binders may be classified by a sieve.

The ball milling method is a method in which hard balls such as ceramics, metals or the like and a material are put into a vessel and the vessel is rotated to grind the material by the shear strength of the ball to obtain solid particles. A method for producing the particulate binders with the ball milling method includes, for example, (i) a step of mixing a material (solid) for a binder with a solvent, and (ii) a step of putting a solvent in which the material for a binder is dispersed and balls made of ceramics or metals into a rotation vessel and then rotating the rotation vessel. The solvent used in the step (i) is not particularly limited as long as it cannot dissolve the above-mentioned material for a binder. The particle size of the resulting particulate binder may be adjusted by the rotation time and the rotation velocity.

The freeze-grinding method is a method in which a raw material is instantaneously cooled by liquid nitrogen or the like to embrittle the material and the embrittled material is ground to obtain particles. The method for producing a particulate binder with the freeze-grinding method includes, for example, (i) a step of cooling a material (solid) for a binder with a low temperature solvent such as liquid nitrogen or the like to embrittle the material, and (ii) a step of pulverizing the material for a binder by applying a mechanical compression force or shear strength with ball milling, hammering, pressing or the like to the embrittled material for a binder. A particulate binder having a desired particle size may be obtained by classifying the pulverized binder by a sieve.

(2) In the second step, the active material particles and the particulate binders are mixed to obtain a mixed powder. In addition, when the particulate binder contains no electrically conductive material, an electrically conductive material is added in this step. In order to mix the active material particles with the particulate binders, a well-known method may be employed, for example, a mixing mill or mixer may be used.

The weight ratio of the active material to the binder in the mixed powder is preferably 100/0.6 to 100/3.0. Further, the weight ratio of the active material to the electrically conductive material in the mixed powder is preferably 100/0.3 to 100/3.0.

In this manner, the present invention is characterized in that the weight ratio of the binder and the electrically conductive material to the active material is lower than that of conventional one.

(3) In the third step, the mixed powder is fixed on the positive electrode current collector to form a positive electrode mixture layer. The positive electrode current collector is, for example, a foil material made of aluminum, aluminum alloy or the like. The production method of a nonaqueous secondary battery of the present invention is characterized by fixing a solid powder on a current collector without dispersing the mixed powder in a solvent.

The means for fixing the mixed powder on the positive electrode current collector is not particularly limited. The method for fixing the mixed powder on the positive electrode current collector includes, for example, (i) a step of placing the mixed powder on the positive electrode current collector, (ii) a step of heating the mixed powder placed on the positive electrode current collector to melt the particulate binders in the mixed powder, and (iii) pressing the mixed powder after the step of heating the mixed powder.

In the step (i), the mixed powder is placed on the positive electrode current collector. In order to place the mixed powder on the current collector, for example, a frame defining the region in which the mixed powder is placed on the current collector is disposed and the mixed powder may be placed in the region defined by the frame. In addition, after the step (i), the mixed powder placed on the current collector may be pressed before the step (ii) and the shape of the mixed powder may be adjusted to increase the density of the mixed powder. As the density of the mixed powder is increased, when the binder is melted in the step (ii), the active material particles are easily bound each other in the mixed powder. The pressure of pressing varies depending on the thickness of the current collector, but is usually 1 to 2 MPa.

Further, in the step (i), instead of the mixed powder, a “mixture layer block” may be placed on the current collector. “The mixture layer block” is formed by placing and heating the mixed powder in a mold to melt the binder in the mixed powder and bonding the active material particles each other.

In the step (ii), the mixed powder placed on the positive electrode current collector is heated to melt the particulate binders in the mixed powder. The means for heating the mixed powder is not particularly limited. Examples of the means for heating the mixed powder include a furnace, a laser, an electronic beam, a heating roll and the like. The mixed powder may be heated to the temperature of melting point of the active material or lower and the temperature of melting point of the binder or higher.

In order to heat the mixed powder with a furnace, the current collector on which the mixed powder is placed may be installed in the furnace. The furnace is not particularly limited, but for example, is an air-heating furnace. In order to heat the mixed powder with a laser or an electronic beam, a laser or an electronic beam may be radiated to the mixed powder placed on the current collector. In order to heat the mixed powder with a heating roll, the mixed powder placed on the current collector may be pressed with the heating roll. A mixture layer strongly bonded to the current collector is formed by melting the particulate binders.

In the step (iii), the mixed powder after heating is further pressed to increase the density of the formed positive electrode mixture layer. The pressure of pressing in the step (iii) is preferably higher than that as described in the step (i). Further, the pressing may be performed twice or more.

In addition, the mixed powder may be fixed on the current collector by an impact solidification method including no step of heating the mixed powder. In the method of fixing the mixed powder on the current collector with the impact solidification method, the mixed powder is mixed with a gas to form an aerosol and the mixed powder is injected through a nozzle to the current collector at a high velocity to bombard the mixed powder with the current collector. Each active material particle and the binder are broken up by the impact force during the mixed powder is bombarded with the current collector, a newly generated interface is exposed, and the active material and the binder are bound to each other by the intermolecular force of the unbound molecules of the newly generated interface.

In this manner, since the production method of the present invention may fix the mixture layer on the current collector by a dry process, convection of the binder, which occurs when the application film is dried, does not occur. Therefore, the localization of the binder along the thickness direction of the mixture layer may be prevented and the mixture layer may be bonded to the current collector with a less amount of the binder.

In addition, according to the production method of the present invention, since the percentage of the binder and the electrically conductive material in the mixture layer are reduced, the percentage of the active material may be increased, and a nonaqueous secondary battery with higher capacity is provided.

As described above, in the production method of the present invention, the positive electrode is preferably produced by a dry process, but the negative electrode may be produced with a dry process in the same manner as that of the positive electrode and may also be produced with a wet process.

When the negative electrode is produced with a wet process, the negative electrode mixture layer is formed on the negative electrode current collector by applying, drying and pressing a paint prepared by dispersing in a solvent the negative electrode active material, the binder for the negative electrode as well as an electrically conductive material and a thickener where necessary. In order to disperse the negative electrode active material, the binder for the negative electrode, an electrically conductive material and a thickener in a solvent, a dispersion machine such as a planetary mixer or the like may be used.

As the binder for the negative electrode, PVDF or its modified form is used, but from the viewpoint of improving the lithium ion acceptability, styrene-butadiene copolymer rubber particles (SBR) or their modified forms, or the like may be used.

The material for a thickener is not particularly limited as long as it is water soluble, but polyethylene oxide (PEO), polyvinyl alcohol (PVA), a cellulose-based resin or its modified form, or the like is preferred. From the viewpoint of the thickening properties and the dispersibility in a solution, a cellulose-based resin such as carboxymethylcellulose (CMC) or the like is especially preferred.

The electrically conductive material contained in the negative electrode mixture layer may be the same as that contained in the positive electrode mixture layer.

2. Nonaqueous Secondary Battery of the Present Invention

The nonaqueous secondary battery of the present invention has an electrode group, a nonaqueous electrolyte and a case enclosing the electrode group and the nonaqueous electrolyte. The nonaqueous secondary battery of the present invention is a nonaqueous secondary battery produced by employing the above-mentioned production method of a nonaqueous secondary battery.

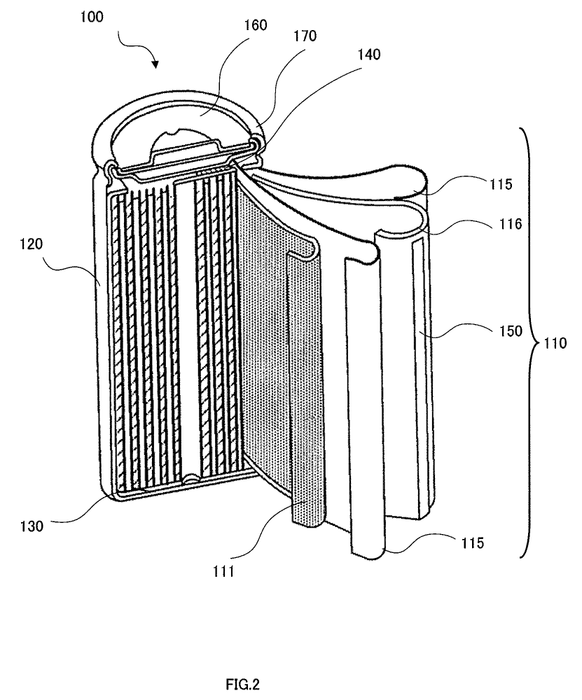

FIG. 2 is a perspective view of the cross-section of the nonaqueous secondary battery of the present invention. As shown in FIG. 2, nonaqueous secondary battery 100 of the present invention has electrode group 110 consisting of positive electrode 111, negative electrode 116 and separator 115; battery case 120; insulating plate 130; positive electrode lead 140; negative electrode lead 150; sealing plate 160; and gasket 170.

Electrode group 110 is accommodated in battery case 120. Further, insulating plate 130 is also accommodated in the battery case 120. An electrolyte composed of a predetermined amount of a nonaqueous solvent and an electrolyte is also poured in battery case 120. Insulating plate 130 insulates electrode group 110 from battery case 120.

The nonaqueous solvent is not particularly limited. The examples of the nonaqueous solvent include ethylene carbonate, propylene carbonate, butylene carbonate, dimethyl carbonate, methylethyl carbonate, diethyl carbonate, γ-butyrolactone, sulfolane, acetonitrile, 1,2-dimethoxyethane, 1,3-dimethoxypropane, diethyl ether, tetrahydrofuran, 2-methyltetrahydrofuran, γ-butyrolactone and the like. These nonaqueous solvents may be used alone, or may be used in combination of two or more kinds. In addition, in order to form an excellent membrane on the positive electrode and the negative electrode or in order to secure stability at the time of overcharge, vinylene carbonate (VC), or cyclohexylbenzene (CHB) or its modified form may be preferably used.

The electrolyte is not particularly limited. The examples of the electrolyte include a lithium salt such as lithium perchlorate (LiClO₄), lithium phosphate hexafluoride (LiPF₆), lithium fluoroborate (LiBF₄), lithium arsenic hexafluoride (LiAsF₆), lithium trifluoromethasulfonate (LiCF₃SO₃), bistrifluoromethyl sulfonylimide lithium [LiN(CF₃SO₂)₂] and the like, and others.

Negative electrode lead 150 derived from electrode group 110 is connected to the bottom of battery case 120 and positive electrode lead 140 derived from electrode group 110 is connected to sealing plate 160 of battery case 120. The opening of battery case 120 is crimp sealed with sealing plate 160 in which gasket 170 is installed in the rim.

The nonaqueous secondary battery of the present invention has features in the electrode group. Hereinafter, the electrode group of the nonaqueous secondary battery of the present invention is explained in detail.

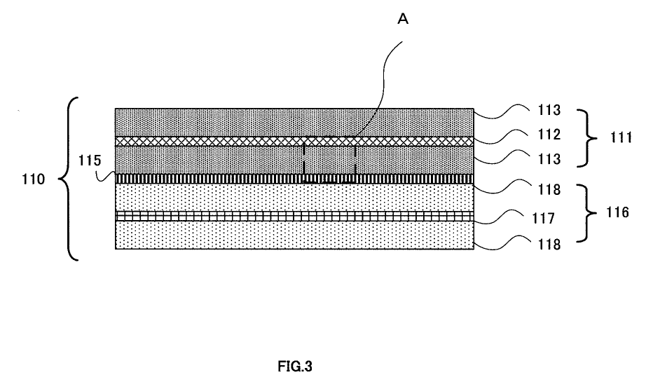

FIG. 3 shows a cross-sectional view parallel to the thickness direction of electrode group 110 shown in FIG. 2. As shown in FIG. 3, electrode group 110 is composed of positive electrode 111 having positive electrode current collector 112 and positive electrode mixture layer 113 disposed on positive electrode current collector 112; negative electrode 116 having negative electrode current collector 117 and negative electrode mixture layer 118 disposed on negative electrode current collector 117; and separator 115 disposed between positive electrode 111 and negative electrode 116.

The positive electrode current collector and the negative electrode current collector are an electrode substrate which holds the positive electrode mixture layer or the negative electrode mixture layer and has a current collecting function. The positive electrode current collector and the negative electrode current collector are not particularly limited as long as they have high electric conductivity. The examples of the positive electrode current collector and the negative electrode current collector include a metal foil such as an aluminum foil, a copper foil, a nickel foil and the like, a laminated product prepared by depositing a metal on the surface of a polymer film such as PET and the like, a conductive polymer film, and others. In general, as the positive electrode current collector, an aluminum foil or an aluminum alloy foil having a thickness of 5 to 30 μm is used, and as the negative electrode current collector, a copper foil having a thickness of 5 to 25 μm may be used.

The positive electrode mixture layer is a layer formed by bonding the positive electrode active material particles with a binder. The binder bonds the current collector and the active material together and the binder also bonds the active material particles each other. The positive electrode mixture layer contains an electrically conductive material and may further contain other substances. In addition, as shown in FIG. 3, the positive electrode mixture layer is generally disposed on both surfaces of the positive electrode current collector.

The examples of the positive electrode active material include a lithium transition metal oxide such as lithium cobalt oxide, lithium nickel oxide, lithium manganese oxide and the like, a transition metal sulfide such as FeS, TiS₂ and the like, an organic compound such as a polyaniline, a polypyrrole and the like, a compound obtained by partial elemental substitution of these compounds, and others. The positive electrode active material particles have an average particle size of from 1 to 100 μm, more preferably from 1 to 50 μm and further more preferably 10 μm. The positive active material in the positive mixture layer has preferably a density of 4.0 to 4.5 g/cc.

The material of the binder is not particularly limited. The examples of the material of the binder include a thermoplastic resin such as a resin containing a fluorine atom, a rubber particle binder having an acrylate unit, and the like. Examples of the resin containing a fluorine atom include a polyvinylidene fluoride (PVDF) and its modified form, polytetrafluoroethylene (PTFE) and the like. The material of the binder may further include an acrylate monomer or acrylate oligomer into which a reactive functional group is introduced.

Examples of the electrically conductive material include carbon black such as acetylene black, ketjen black, channel black, furnace black, lamp black, thermal black and the like, and various graphites.

The negative electrode mixture layer is a layer formed by bonding the negative electrode active material particles with a binder. The negative electrode mixture layer contains an electrically conductive material and may further contain other substances. In addition, as shown in FIG. 3, the negative electrode mixture layer is generally disposed on both surfaces of the negative electrode current collector.

The examples of the material of the negative electrode active material include a carbonaceous active material such as graphite, cokes and the like, metal lithium, lithium transition metal nitride, and a silicon-based composite material such as silicate and the like.

Examples of the material of binder contained in the negative electrode mixture layer include a polyvinylidene fluoride (PVDF) and its modified form, styrene-butadiene copolymer rubber particles (SBR) and their modified forms, and the like. In addition, the electrically conductive material contained in the negative electrode mixture layer may be the same as the electrically conductive material contained in the positive electrode mixture layer.

The separator is not particularly limited as long as it insulates the positive electrode from the negative electrode and lithium ions can transfer through the inside of the separator (inside of the material constituting the separator or inside of pores formed in the separator) and the material of the separator is stable during the lithium ion battery is used. The separator may be for example an insulating porous polymer film. The separator may be formed, for example, by applying, drying and rolling a mixture composed of inorganic particles, organic particles, or a mixture of inorganic particles and organic particles, and a binder, a solvent, various additives and the like. The examples of the material of the inorganic particle include alumina silica, magnesium oxide, titanium oxide, zirconia, silicon carbide, silicon nitride and the like. The examples of the material of the organic particle include polyethylene, polypropylene, polystyrene, polyacrylonitrile, polymethylmethacrylate, polyvinylidene fluoride, polytetrafluoroethylene, polyimide and the like. The thickness of the separator is not particularly limited, and for example, is 10 to 25 μm.

The nonaqueous secondary battery of the present invention is characterized in that the positive electrode mixture layer or the negative electrode mixture layer has particulate binders adhered to the surface of the active material particle. Here, “particulate” means “nearly spherical”. Any one of the positive electrode mixture layer and the negative electrode mixture layer may have particulate binders adhered to the surface of the active material particle, preferably, the positive electrode mixture layer has particulate binders adhered to the surface of the active material particle, and more preferably, both of the positive electrode mixture layer and the negative electrode mixture layer have particulate binders adhered to the surface of the active material particle. Hereinafter, a case in which the positive electrode mixture layer has particulate binders adhered to the surface of the active material particle is explained.

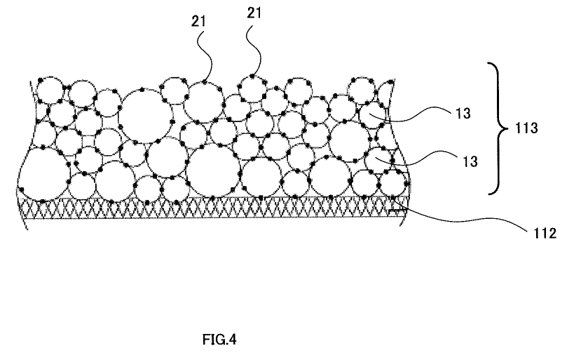

FIG. 4 is a cross-sectional view of positive electrode mixture layer 113. As shown in FIG. 4, positive electrode mixture layer 113 has positive electrode active material particles 13 and particulate binders 21 adhered to the surface of the positive electrode active material particle 13.

The average particle size of the particulate binders is preferably 1/1000 to 1/10 of that of the positive electrode active material particle. Specifically, the particulate binders have an average particle size of preferably from 0.01 to 10 μm and more preferably from 0.05 to 0.15 μm. The particle size of the positive electrode active material particle and the average particle size of the particulate binders may be measured by calculating an average particle size corresponding to the area of the positive electrode active material particles and the particulate binders, as measured by the SEM photograph of the cross-sectional view of the positive electrode mixture layer. In addition, the positive electrode mixture layer contains the particulate binder preferably in an amount of from 0.6 to 3.0 parts by weight, more preferably from 0.6 to 2.2 parts by weight and further more preferably from 0.6 to 1.8 parts by weight, with respect to 100 parts by weight of the positive electrode active material.

Further, the particulate binder may contain an electrically conductive material. When the particulate binder contains an electrically conductive material, the positive electrode mixture layer contains the electrically conductive material in an amount of preferably from 0.3 to 3.0 parts by weight, more preferably from 0.3 to 2.5 parts by weight and further more preferably from 0.3 to 0.9 parts by weight, with respect to 100 parts by weight of the positive electrode active material.

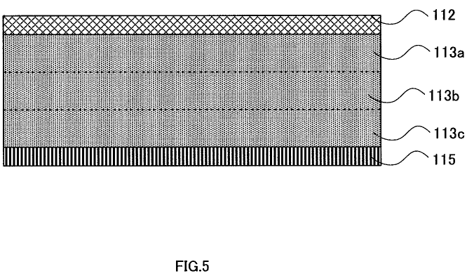

In addition, the present invention is characterized in that the particulate binders are uniformly dispersed in the positive electrode mixture layer. Here, “the binders are uniformly dispersed in the positive electrode mixture layer” means that the difference between the percentage of the binders in an optional region of the positive electrode mixture and the percentage of the binder in the whole positive electrode mixture layer is not over 2%. Hereinafter, the state in which “the binders are uniformly dispersed in the positive electrode mixture layer” is explained with reference to FIG. 5.

FIG. 5 is an enlarged view of dashed square A of FIG. 3. In FIG. 5, positive electrode mixture layer 113 is divided into three equal slices of layer; layer 113a having a surface contacting with positive electrode current collector 112, layer 113c having surface contacting with separator 115 and layer 113b sandwiched between layer 113a and layer 113c.

In the present invention, for example, when the volume percentage of the binders in the whole positive electrode mixture layer 113 composed of layer 113a, layer 113b and layer 113c (hereinafter, referred to as an “average percentage of the binder”) is defined as X (vol/vol %), the volume percentage of the binder in layer 113a is defined as Y (vol/vol %) and the volume percentage of the binder in layer 113c is defined as Z (vol/vol %), the following equations are satisfied.

X−2≦Y≦X+2

X−2≦Z≦X+2

In addition, when the binder contains a resin containing a fluorine atom, it may be confirmed whether the binder is uniformly dispersed in the positive electrode mixture layer by measuring the fluorine concentration in the positive electrode mixture layer. For example, when the fluorine atom concentration in the whole positive electrode mixture layer 113 composed of layer 113a, layer 113b and layer 113c shown in FIG. 5 is defined as X (% by vol.), the fluorine atom concentration in layer 113a is defined as Y (% by vol.), and the fluorine atom concentration in layer 113c is defined as Z (% by vol.), the following equations are satisfied.

X−2≦Y≦X+2

X−2≦Z≦X+2

The method for measuring the fluorine atom concentration in the positive electrode mixture layer is not particularly limited, but for example, includes (i) a step of preparing a distribution chart of the fluorine atom in the cross-section of the positive electrode mixture layer and (ii) a step of calculating the fluorine atom concentration in the positive electrode mixture layer from the distribution chart of the fluorine atom.

In the step (i), for example, the cross-section of the positive electrode mixture layer is imaged with an Electron Probe Micro Analysis (EPMA) equipment or the like and a distribution chart of a fluorine atom may be prepared from the image. In the step (ii), for example, the average brightness of the distribution chart of a fluorine atom is determined by converting the distribution chart of a fluorine atom prepared in the step (i) to a 256 gray-scale image and the fluorine atom concentration in the positive electrode mixture layer may be calculated from the average brightness determined.

In this manner, the nonaqueous secondary battery of the present invention has a high percentage of the positive electrode active material in the positive electrode mixture layer and thus has high capacity. In addition, in the nonaqueous secondary battery of the present invention, the particulate binders are adhered on the surface of the positive electrode active material, and the positive electrode active material is not covered with a binder as in a conventional nonaqueous secondary battery. For this reason, in the nonaqueous secondary battery of the present invention, only a little surface area of the positive electrode active material is covered with a binder. Accordingly, since the positive electrode active material can more efficiently absorb and release a lithium ion, the nonaqueous secondary battery of the present invention has higher capacity.

### Embodiments

[Preparation of Particulate Binder]

Acetylene black (manufactured by Denki Kagaku Kogyo Kabushiki Kaisha) was added and mixed as an electrically conductive material into an N-methyl-2-pyrrolidone (manufactured by Mitsubishi Chemical Corporation) solution in which the concentration of PVDF (KF Polymer (trademark), manufactured by Kureha Corporation) was 8% by weight to prepare a material solution of a particulate binder containing an electrically conductive material. The weight ratio of an acrylate resin to acetylene black in material solution was set at 2.2: 2.5. Thereafter, the prepared material solution was sprayed using a spray head (manufactured by Nordson K. K.), and dried at 200° C. to prepare the particulate binders having an average particle size of 0.01 to 10 μm.

[Preparation of Mixed Powder]

A mixed powder was prepared by mixing the prepared particulate binder and a positive electrode active material (lithium cobalt oxide, manufactured by Sumitomo Metal Mining Co., Ltd.) having an average particle size of 1 to 100 μm by a mixer so that the weight ratio of the particulate binder to the positive electrode active material was 2.2:100.

[Preparation of Positive Electrode Mixture Layer]

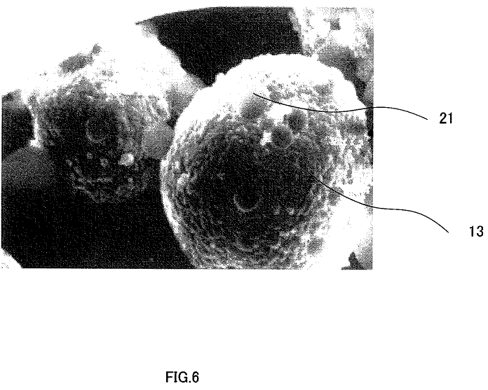

The prepared mixed powder was placed on an aluminum foil having a thickness of 30 μm in an amount of 0.2 g per 1 cm² of the aluminum foil. Thereafter, the mixed powder placed on the aluminum foil was pressed with a flat press. The pressure of pressing was 1 kg/cm². Subsequently, the aluminum foil on which the mixed powder was placed was left to stand in an air-heating furnace maintained at 200° C. for two hours to obtain a positive electrode mixture layer fixed on the positive electrode current collector. FIG. 6 shows a scanning electron microscope (SEM) photograph of a cross-section of the resulting positive electrode mixture layer.

The positive electrode active material is represented by 13 in FIG. 6 and the binder is represented by 21. As shown in FIG. 6, binder 21 is a spherical particle and is adhered to the surface of positive electrode active material 13. In addition, it is understood that the average particle size of binders 21 is approximately 1/10 to 1/1000 of that of positive electrode active material 13.

According to the method for producing a nonaqueous secondary battery relating to the present invention, since the uniform distribution of a binder in a mixture layer is obtained, a desired bonding strength may be secured with a less amount of a binder compared to the method of forming a mixture layer by a wet process, and therefore the density of an active material may be increased.

In addition, according to the production method of the present invention, since the uniform distribution of an electrically conductive material in a mixture layer is obtained, a desired bonding strength may be secured with a less amount of an electrically conductive material. therefore, the density of an active material may be increased. As a result, a nonaqueous secondary battery with high capacity and less cycle degradation is provided according to the present invention.
11 Current collector
13 Active material
15 Solution containing a binder
17 Application film
19 Mixture layer
21 Binder
100 Nonaqueous secondary battery
110 Electrode group
111 Positive electrode
112 Positive electrode current collector
113 Positive electrode mixture layer
115 Separator
116 Negative electrode
117 Negative electrode current collector
118 Negative electrode mixture layer
120 Battery case
130 Insulating plate
140 Positive electrode lead
150 Negative electrode lead
160 Sealing plate
170 Gasket

What is claimed is:

1. A nonaqueous secondary battery, comprising:
a positive electrode having a positive electrode current collector and a positive electrode mixture layer disposed on the positive electrode current collector,
a negative electrode having a negative electrode current collector and a negative electrode mixture layer disposed on the negative electrode current collector, and
a separator disposed between the positive electrode and the negative electrode,
the positive electrode mixture layer or the negative electrode mixture layer containing active material particles and particulate binders adhered to the surface of the active material particle.

2. The nonaqueous secondary battery according to claim 1, wherein
the average particle size of the particulate binders is 1/1000 to 1/10 of the average particle size of the active material particles.

3. The nonaqueous secondary battery according to claim 1, wherein
the particulate binders have an average particle size of 0.01 to 10 μm.

4. The nonaqueous secondary battery according to claim 1, wherein
the active material particles have an average particle size of 1 to 50 μm and the particulate binders have an average particle size of 0.05 to 0.15 μm.

5. The nonaqueous secondary battery according to claim 1, wherein
the mixture layer containing the active material particles and the particulate binders contains the particulate binders in an amount from 0.6 to 3.0 parts by weight with respect to 100 parts by weight of the active material particles.

6. The nonaqueous secondary battery according to claim 1, wherein
an electrical conductive material is contained in the particulate binder, and
the mixture layer containing the active material particles and the particulate binders contains the electrically conductive material in an amount from 0.3 to 3.0 parts by weight with respect to 100 parts by weight of the active material particles.

7. The nonaqueous secondary battery according to claim 1, wherein the binder is a resin containing a fluorine atom.

8. The nonaqueous secondary battery according to claim 1, wherein
the following conditions are satisfied: X−2≦Y≦X+2 and X−2≦Z≦X+2,
when the mixture layer containing the active material particles and the particulate binders is divided into three equal slices of layer: a layer A having a surface contacting with the positive electrode current collector or the negative electrode current collector, a layer C having a surface contacting with the separator, and a layer B sandwiched between the layer A and the layer C,
the volume percentage of the binder in the whole mixture layer, containing the active material particles and the particulate binders is defined as X (vol/vol %),
the volume percentage of the binder in the layer A is defined as Y (vol/vol %), and
the volume percentage of the binder in the layer C is defined as Z (vol/vol %).

9. The nonaqueous secondary battery according to claim 7, wherein
the following conditions are satisfied: X−2≦Y≦X+2 and X−2≦Z≦X+2,
when the mixture layer containing the active material particles and the particulate binder is divided into three equal slices of layer: a layer A having a surface contacting with the positive electrode current collector or the negative electrode current collector, a layer C having a surface contacting with the separator, and a layer B sandwiched between the layer A and the layer C,
the fluorine atom concentration in the whole mixture layer containing the active material particles and the particulate binders is defined as X (vol %),
the fluorine atom concentration in the layer A is defined as Y (vol %), and
the fluorine atom concentration in the layer C is defined as Z (vol %).

10. A nonaqueous secondary battery, comprising:
an electrode group including a positive electrode having a positive electrode current collector and a positive electrode mixture layer disposed on the positive electrode current collector, a negative electrode having a negative electrode current collector and a negative electrode mixture layer disposed on the negative electrode current collector, and a separator disposed between the positive electrode and the negative electrode;
a nonaqueous electrolyte; and
a case enclosing the electrode group and the nonaqueous electrolyte,
the positive electrode mixture layer or the negative electrode mixture layer containing active material particles and particulate binders adhered to the surface of the active material particle.

11. A method for producing a nonaqueous secondary battery including a positive electrode having a positive electrode current collector and a positive electrode mixture layer disposed on the positive electrode current collector, a negative electrode having a negative electrode current collector and a negative electrode mixture layer disposed on the negative electrode current collector, and a separator disposed between the positive electrode and the negative electrode, comprising the steps of:
providing active material particles and particulate binders,
mixing the active material particles and the particulate binders to obtain a mixed powder, and
fixing the mixed powder on the positive electrode current collector or the negative electrode current collector.

12. The method for producing the nonaqueous secondary battery according to claim 11, wherein
the particulate binder contains an electrically conductive material, and
the step of providing the particulate binders includes the steps of preparing a solution containing a raw material for the binder, the electrically conductive material and a solvent; spraying the solution to make the solution in a droplet state; and drying the solution in a droplet state to make the particulate binders containing the electrically conductive material.

13. The method for producing the nonaqueous secondary battery according to claim 12, wherein
the concentration of the material for the binder is 4 to 12% by weight and the concentration of the electrically conductive material is 5 to 20% by weight in the solution.

14. The method for producing the nonaqueous secondary battery according to claim 11, wherein
the particulate binders have an average particle size of 0.01 to 10 μm.

15. The method for producing the nonaqueous secondary battery according to claim 11, wherein
the step of fixing includes the steps of placing the mixed powder on the positive electrode current collector or the negative electrode current collector, and heating the placed mixed powder to melt the particulate binders in the mixed powder.
